(19) United States
(12) Patent Application Publication
(10) Pub. No.: US 2025/0128343 A1
(43) Pub. Date: Apr. 24, 2025

(54) METHOD FOR GRINDING A GEARING

(71) Applicant: Klingelnberg GmbH, Hückeswagen (DE)

(72) Inventors: Sebastian Stramm, Köln (DE); Christof Gorgels, Köln (DE)

(21) Appl. No.: 18/920,213

(22) Filed: Oct. 18, 2024

(30) Foreign Application Priority Data
Oct. 20, 2023 (EP) 23205043.5

(51) Int. Cl. B23F 23/12

(52) U.S. Cl. CPC B23F 23/1218

(57) ABSTRACT

A method for grinding a gearing includes the steps of: grinding a gearing of a component using a gear grinding machine, wherein component-specific machine data, such as machining parameters, spindle currents, control deviations or the like, are recorded during the grinding of the component; determining one or more results of a computer-implemented rolling test of the gearing of the component by transferring the component-specific machine data or parameters derived therefrom as input data to a data model, wherein the data model has correlations between results of test bench-based rolling tests and component-specific machine data assigned to the results of test bench-based rolling tests, and wherein the output data of the data model determined on the basis of the input data correspond to the result or results of the computer-implemented rolling test to be determined.

### CROSS-REFERENCE TO RELATED APPLICATIONS

This application claims the benefit of European patent application no. 23205043.5, filed on 20 Oct. 2023, the disclosure of which is incorporated herein by reference in its entirety.

### TECHNICAL FIELD

The present disclosure relates to a method for grinding a gearing of a component by means of a gear grinding machine, wherein a plurality of component-specific machine data, such as machining parameters, spindle currents, control deviations or the like, are recorded during the grinding of the component.

### BACKGROUND

Gearings are often manufactured using the process chain “pre-cutting”, “hardening” and “hard finishing”. Hard finishing can be carried out by grinding the gearing, for example.

Quality control loops are used in accordance with the prior art to ensure that the required tolerances are met for gearings manufactured in series production, for example. Here, the manufactured gearings are measured and/or tested in order to determine deviations of the manufactured gearing from specified target values of the gearing. Based on the deviations, the component can be classified as a good or bad part and, optionally, subjected to reworking, and the deviations can also be used to derive corrections for the corresponding production steps for manufacturing the gearing.

The basis of such a quality control loop are therefore deviations determined on a relevant gearing of a component, so that, for example, the above-mentioned corrections for a grinding process are determined on the basis of component deviations.

Gearings that are used in the drivetrains of electric motor-driven vehicles, for example, are often tested for their noise behavior in so-called rolling tests. Since transmission noise is no longer masked by the engine noise in purely electric motor-driven vehicles, or is masked to a lesser extent by the engine noise, it is essential that no noisy gearings are delivered and installed in such purely electric motor-driven vehicles. In many cases, therefore, 100% testing is carried out on all gearings manufactured in series production for electric mobility. It is clear that this results in a considerable testing effort. The rolling test is not an end-of-line test on an end-of-line test bench (EOL test bench). This means that the rolling test of the component is not carried out in the final installation situation in a gearbox, but by rolling with a master gear or an associated mating gear.

It is also known that axes and drives of gear grinding machines are monitored during machine operation in order to identify defects or a need for maintenance of a relevant gear grinding machine and/or component deviations. Publication DE102018122041A1, which goes back to the applicant, describes the approach of calculating a “virtual” twin of the manufactured component on the basis of component-specific machine data recorded during production. This virtual twin is analyzed with computer support in order to identify noise anomalies and/or machine defects. The disadvantage here is that calculating and analyzing the virtual twin requires a great deal of computing power. Furthermore, the accuracy of the calculation of the virtual twin depends on the exact knowledge of the deviations of the tool geometry as well as the machine axes and drives.

While the classic quality control loop is based purely on measured test bench data, the approach according to publication DE102018122041A1 is purely data-driven, wherein both approaches are time-consuming.

### SUMMARY

Against this background, the present disclosure is based on the technical problem of specifying a method that enables a reduction in the testing effort for the rolling test. Furthermore, a method for manufacturing a plurality of components is to be specified.

The technical problem described above is solved in each case with the features of the independent claims. Advantageous designs of the disclosure result from the dependent claims and the following description.

According to a first aspect, the disclosure relates to a method comprising the following method steps: grinding a gearing of a component by means of a gear grinding machine, wherein a plurality of component-specific machine data, such as machining parameters, spindle currents, control deviations or the like, are recorded during the grinding of the component; characterized by determining one or more results of a computer-implemented rolling test of the gearing of the component by transferring the component-specific machine data or parameters derived therefrom as input data to a data model, wherein the data model has correlations between results of test bench-based rolling tests and component-specific machine data assigned to the results of test bench-based rolling tests, and wherein output data of the data model determined on the basis of the input data correspond to the result or results of the computer-implemented rolling test to be determined.

According to the disclosure, component-specific machine data is therefore evaluated using a data model that is based on real test bench data. In this way, the advantages of the conventional quality control loop based on measured deviations can be combined with those of a data-driven approach. No complex and computationally intensive simulations are required to predict the expected results of a rolling test for a recorded data set of component-specific machine data.

The rolling test is not an end-of-line test on an end-of-line test bench (EOL test bench). This means that the rolling test of the component is not carried out in the final installation situation in a gearbox, but by rolling with a master gear or an associated mating gear.

In this text, the characteristic “test bench-based rolling tests” means that these are real practical tests that have been carried out for ground gearings on a rolling test bench. The term “test bench-based” can therefore also be replaced synonymously by the term “real” or “practical”, as the test bench-based rolling tests are real or practical rolling tests on a rolling test bench.

If the characteristic “computer-implemented rolling test” is used here, this means that this is a virtual rolling test or a computer-aided rolling test. The computer-implemented rolling test is therefore data processing with a computer on which a software program product is executed, which comprises the data model or accesses the data model in order to determine results of the virtual or computer-aided rolling test as output data from the component-specific machine data as input data.

The data model can, for example, have at least one AI model, wherein the abbreviation “AI” is known to stand for “artificial intelligence”. The AI model may have been trained using training data, with the training data comprising the results of test bench-based rolling tests of components and component-specific machine data assigned to these components.

The results of the test bench-based rolling tests may include the results of test bench tests, namely single flank rolling tests and/or double flank rolling tests. It may be provided that a test bench for single flank rolling tests has been used to determine the training data. Alternatively or additionally, it may be provided that a test bench for double flank rolling tests has been used to determine the training data.

It may be provided that the training data and the AI model trained with the training data are machine-specific and therefore assigned to a specific gear grinding machine. Alternatively, it may be provided that training data is generated for several gear grinding machines so that the training data is determined using components that have been manufactured using different gear grinding machines.

According to one design of the method, it may be provided that one or more of the test characteristics listed below are output as quantitative and/or qualitative results of the computer-implemented rolling test using the data model: center distance, radial runout, rolling step, rolling deviation, two-ball dimension, runout error, long-wave and/or short-wave tooth-to-tooth amplitude, maximum rolling deviation, torsional error and dynamic backlash, noise behavior, surface error. In particular, it may be provided that quantitative and/or qualitative results of the computer-implemented rolling test are output, which include pitch errors for a particular gearing.

It may be provided that the data model has an AI model for the respective output test characteristic. It may therefore be provided that an AI model has been generated for each individual test characteristic and trained using training data. The data model can therefore have a number of AI models, in particular a separate AI model for each individual test characteristic.

According to one design of the method, it may be provided that the AI model assigned to a respective test characteristic is an artificial neural network or a classification model.

It may be provided that a frequency analysis, such as an FFT analysis or the like, may be carried out on the basis of the result of the computer-implemented rolling test or the computer-implemented results of the rolling test in order to determine dominant frequencies during the rolling of the gearing.

Alternatively or additionally, it may be provided that the result of the computer-implemented rolling test is a dominant frequency during the rolling of the gearing.

Alternatively or additionally, it may be provided that the results of the computer-implemented rolling test are dominant frequencies during the rolling of the gearing.

According to one design of the method, it may be provided that machine corrections for the gear grinding machine are determined on the basis of the results of the computer-implemented rolling test of the gearing, in particular by means of multi-objective optimization.

It may be the provided that the machine corrections have changes for process parameters of the gear grinding machine, wherein the process parameters are within an n-dimensional process window, wherein the process window is limited by process restrictions, such as maximum permissible axis and/or drive speeds and/or accelerations, collision structures within a machine area, maximum permissible tool and/or workpiece temperatures, grinding burn or the like.

Process parameters can be, for example, the known process parameters of a grinding process, such as a feed rate, a tool speed, a grinding path per stroke, a shift path per stroke path, a metal removal rate, an infeed or cutting depth or similar.

According to one design of the method, it may be provided that an extrapolatable model is provided for at least one process parameter, such as a linear regression model, an AI model or the like, wherein the extrapolatable model maps a correlation between the process parameter and a process constraint and wherein the extrapolatable model enables compliance with a process constraint to be checked for a change in the process parameter specified by the machine correction.

For example, such an extrapolatable model can show the influence of a feed rate and/or a tool speed and/or a metal removal rate on the formation of grinding burn, so that it can be checked whether or not grinding burn occurs for the proposed machine corrections and the resulting changed process parameters. A further example would be the checking of a mechanical or thermal stress on the grinding tool for the changed process parameters, wherein a separate extrapolatable model can be specified for the mechanical stress and the thermal stress in each case.

The specification of one or more extrapolatable models therefore serves to check the practical applicability of corrections for the process parameters derived from the computer-implemented rolling tests.

It may be the provided that the process parameters resulting from the machine corrections are checked with regard to a stability criterion, in particular that the machine parameters are robust against process fluctuations and/or that the machine corrections reflect a stationary state of the gear grinding machine.

Certain combinations of process parameters can lead to a grinding process becoming unstable if there are only minor deviations from these process parameters, i.e. no longer enabling satisfactory component quality. The stability criterion is therefore used to check how sensitive the modified process parameters resulting from the corrections are with regard to parameter fluctuations.

The data model, which contains the relationship between component-specific machine data and the results of rolling tests, can also be used for this purpose. The data model can thus be used to determine the expected results of the rolling tests and thus the component quality for variations in the process parameters in the immediate vicinity of these process parameters. In this way, it is possible to predict the extent to which the component quality will continue to be maintained for minor process fluctuations.

Furthermore, the stability criterion can be used to check the extent to which the machine corrections enable a stationary state or stationary operation of the gear cutting machine. This means that it is checked to what extent the process, which is now carried out with process parameters changed by the machine corrections, is a stable process, for example in relation to tool wear. Here again, an extrapolatable model can be specified, which indicates the relationship between tool wear and one or more process parameters. This stability criterion could also be used as a process limitation or process barrier, as described above, so that changed process parameters or machine corrections are rejected if tool wear is too high.

Separate AI models with separate training data, based on practical measurements and tests, can be provided for both the stability criteria and the process constraints.

According to one design of the method, it may be provided that the machine data comprise axis movements and/or axis accelerations and/or vibration data of a machine axis or several controlled machine axes of the gear grinding machine, wherein the results of the computer-implemented rolling tests include periodic deviations of the actual geometry of the gearing from a nominal geometry of the gearing, and wherein the data model in particular maps correlations between the periodic deviations of the actual geometry of the gearing and the axis movements and/or axis accelerations and/or vibration data of the gear grinding machine.

Controlled machine axes exhibit vibration behavior for certain movement or acceleration profiles, particularly in the range of their natural frequencies, which can be transmitted to the tooth flanks during grinding. Vibrations of the machine axes are usually not transferred 1 to 1 into waviness to be measured on the tooth flank or deviations to be measured on the gearing, but rather a transfer function results due to the machine kinematics and the corresponding gear ratios, with which certain vibrations of individual machine axes are mapped on the gearing. The relationship between such a vibration excitation of a machine axis and the corresponding deviations to be measured on the gearing can be represented in each case via a transfer function. It may be provided that the data model therefore represents one or more transfer functions for one or more machine axes, so that periodic deviations of the gearing can be determined as output data using axis movements or acceleration profiles as input data for the data model.

According to a further aspect, the disclosure relates to a method comprising the method steps of: carrying out a method according to one of the preceding claims for a plurality of components; carrying out a test bench-based rolling test for one or more of the components to validate and/or improve the data model.

The data model can therefore be successively improved and/or validated. For example, it may be provided that those components that have been classified as bad parts by means of the computer-implemented rolling test are subjected to a practical test, i.e. a test bench-based rolling test, in order to confirm the results of the computer-implemented rolling test. The results of the test bench-based rolling test can be used as additional training data for the computer-implemented rolling test, provided that it is an AI model trained using training data.

If a gear grinding process for a new gear geometry is set up for series production, it may be provided, for example, that all manufactured components are first subjected to a test bench-based rolling test. The results of the test bench-based rolling test and the associated component-specific machine data are used to train an AI model until the AI model reproduces the results of the test bench-based rolling test with a specified accuracy. This means that test bench-based rolling tests are carried out until the AI model has been successfully validated.

In other words, a validation loop can be carried out in the manner described above until the specified model quality is achieved. For example, it may be provided that the specified model quality for validation is achieved when a coefficient of determination is greater than 0.8, in particular greater than 0.9, in particular greater than 0.95.

Once the specified model quality has been achieved, series production can be switched from test bench-based rolling test to computer-implemented rolling test, so that test bench-based rolling tests are only used when necessary.

If a sufficient database is already available for a specific gear grinding process, it is possible to completely dispense with test bench-based generating tests—even when setting up the gear grinding process.

### BRIEF DESCRIPTION OF THE DRAWING

The disclosure is described in more detail below with reference to a drawing Illustrating exemplary embodiments. It shows schematically:

FIG. 1 shows a flow chart of a method according to the disclosure.

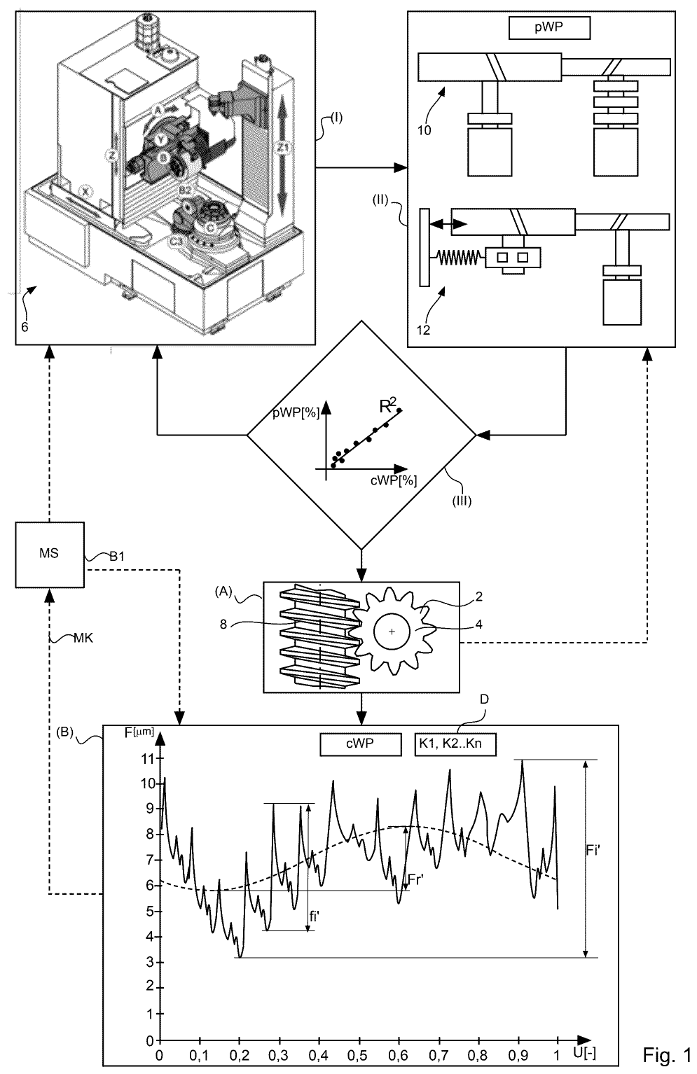

### DETAILED DESCRIPTION OF THE DRAWING

The method according to the disclosure has a method step (A) which comprises grinding a gearing 2 of a component 4 by means of a gear grinding machine 6. Such a gear grinding machine 6 is shown as an example for a method step (I), which will be described in detail below.

During the grinding of the gearing 2 of the component 4 in method step (A), a plurality of component-specific machine data are recorded, such as machining parameters, spindle currents, control deviations of the gear grinding machine 6 or the like. Machining parameters are therefore, for example, feed rates or speeds of a grinding tool 8, a cutting depth, a metal removal rate, a stroke speed, a shift path per stroke path or the like, i.e. those parameters that are required to define the grinding process on the gear grinding machine 6. In the present case, the grinding process involves continuous generating grinding by means of a grinding tool 8 designed as a grinding worm.

After grinding the gearing 2 of the component 4, one or more results of a computer-implemented rolling test of the gearing 2 of the component 4 are determined in a method step (B).

This computer-implemented rolling test cWP is carried out by transferring the component-specific machine data or parameters derived therefrom as input data to a data model, wherein the data model has correlations between results of test bench-based rolling tests pWP and component-specific machine data assigned to the results of test bench-based rolling tests pWP and wherein output data of the data model determined on the basis of the input data correspond to the result or results of the computer-implemented rolling test cWP to be determined.

With regard to method step (B), the result of a computer-implemented rolling test cWP is shown as an example, wherein the rotational error F is shown schematically in [mm] plotted over one revolution U of the component 4—i.e. a result of a single flank rolling test of the toothed component 4. From this, values for the first-order runout Fr′, the tooth-to-tooth amplitude fi′ and the maximum rolling deviation Fi′, for example, can be determined in a known manner. According to alternative exemplary embodiments of the disclosure, it may be provided that in method step (B) pitch errors of the gearing 2 are determined by means of the computer-implemented rolling test.

The data model cWP can have an AI model, wherein the AI model has been trained using training data. The training and validation of the AI model is described below using method steps (I), (II) and (III).

A plurality of gearings 2 on a plurality of components 4 are first successively ground by means of the gear grinding machine 6 in method step (I), wherein each of these components 4 is subjected to a test bench-based rolling test pWP after grinding, wherein this test bench-based rolling test takes place in method step (II). For this purpose, a test bench 10 for the single flank rolling test and a test bench 12 for the double flank rolling test are shown as examples and schematically with regard to method step (II).

The results of the test bench-based rolling test pWP and the associated component-specific machine data are used to train the AI model.

Method steps (I), (II) and (III) are repeated until a coefficient of determination greater than 95% is achieved, i.e. until the AI model reproduces the results of the practical rolling test pWP with a high degree of accuracy.

The method steps (I), (II) and (III) can also be described as a validation or training loop for the AI model.

One or more of the test characteristics listed below can be output as quantitative and/or qualitative results of the computer-implemented rolling test using the data model: center distance, radial runout, rolling step, rolling deviation, two-ball dimension, runout error, long-wave and/or short-wave tooth-to-tooth amplitude, maximum rolling deviation, torsional error and dynamic backlash, noise behavior, surface error, pitch error.

It may be provided that a separate AI model is trained and validated for each individual test characteristic, so that a separate AI model is available for each test characteristic. The data model D can therefore have a plurality of AI models K1, K2 . . . Kn, each of which has been trained and validated.

Machine corrections MK for the gear grinding machine 6 can be determined on the basis of the results of the computer-implemented cWP gear generating test, in particular by means of multi-objective optimization. Corrected values for feed rates or speeds of the grinding tool 8, depth of cut, metal removal rate, stroke speed, shift path per stroke path or the like, i.e. those parameters that are required to define the grinding process on the gear grinding machine 6, can be specified in order to improve the grinding result or the quality of the gearing with regard to the test characteristics of the generating test.

After the corrections MK of the production parameters of the gear grinding machine have been made, the AI model or AI models K1, K2 . . . Kn can be validated again using method steps (I), (II) and (III).

Machine corrections MK can affect both the gear grinding performed by the gear grinding machine 6 and the dressing of the grinding tool 8 performed by the gear grinding machine 6.

Before being applied to the gear grinding machine 6, the corrections MK can be checked in a method step (B1) for compliance with process constraints and/or with regard to their stability. Thus, it may be provided that an extrapolatable model MS is provided for at least one process parameter, such as a linear regression model, an AI model or the like, wherein the extrapolatable model MS maps a correlation between the process parameter and a process constraint and wherein the extrapolatable model enables compliance with a process constraint to be checked for a change in the process parameter specified by the machine correction MK.

If method step (B1) shows that process constraints and/or a stability criterion are not met, adjusted corrections can be determined using multi-objective optimization and checked again in step (B1).

It may also be provided that gearings 2 that have been identified as bad parts by means of the computer-implemented rolling test cWP are fed to the test bench-based rolling test pWP in order to check the results of the computer-Implemented rolling test cWP. The results of the test bench-based rolling test pWP can be used together with the associated component-specific machine data as training data to improve the AI model or AI models K1, K2 . . . Kn.

It may be provided that during series production, individual gearings 2 are tested using the test bench-based rolling test pWP, both for components 4 declared as good parts and as bad parts using the computer-implemented rolling test cWP, in order to generate further training data for improving the AI model or AI models K1, K2 . . . Kn.

According to an exemplary embodiment of the disclosure, the machine data may comprise axis movements and/or axis accelerations and/or vibration data of one machine axis or several controlled machine axes X, Y, Z, A, B, C, B2, C3 of the gear grinding machine 6, wherein the results of the computer-implemented rolling tests cWP contain periodic deviations of the actual geometry of the gearing 2 from a nominal geometry of the gearing 2, and wherein the data model D in particular represents correlations between the periodic deviations of the actual geometry of the gearing 2 and the axis movements and/or axis accelerations and/or vibration data of the gear grinding machine 6.

1. A method for grinding a gearing including the steps of:
grinding a gearing of a component using a gear grinding machine, wherein a plurality of component-specific machine data, such as machining parameters, spindle currents, or control deviations, are recorded during the grinding of the component, and
whereby
determining one or more results of a computer-implemented rolling test of the gearing of the component by
transferring the component-specific machine data or parameters derived therefrom as input data to a data model,
wherein the data model has correlations between results of test bench-based rolling tests and component-specific machine data assigned to the results of test bench-based rolling tests, and
wherein the output data of the data model determined on the basis of the input data correspond to the result or results of the computer-implemented rolling test to be determined.

2. The method according to claim 1,
wherein
the data model has at least one AI model,
wherein the AI model has been trained using training data and
wherein the training data comprises the results of test bench-based rolling tests of components and component-specific machine data assigned to these components.

3. The method according to claim 2,
wherein
the results of the test bench-based rolling tests comprise the results of test bench tests, namely single flank rolling tests and/or double flank rolling tests.

4. The method according to claim 3,
wherein one or more of the test characteristics listed below are output as quantitative and/or qualitative results of the computer-implemented rolling test using the data model:
center distance, radial runout, rolling step, rolling deviation, two-ball dimension, runout error, long-wave and/or short-wave tooth-to-tooth amplitude, maximum rolling deviation, torsional error and dynamic backlash, noise behavior, surface error, pitch error.

5. The method according to claim 4,
wherein the data model has an AI model for the respective output test characteristic.

6. The method according to claim 5,
wherein the AI model assigned to a respective test characteristic is an artificial neural network or a classification model.

7. The method according to claim 1,
wherein
a frequency analysis, such as an FFT analysis, is carried out on the basis of the result of the computer-implemented rolling test or the results of the computer-implemented rolling test in order to determine dominant frequencies during the rolling of the gearing
and/or
the result of the computer-implemented rolling test is a dominant frequency during the rolling of the gearing
and/or
the results of the computer-implemented rolling test are dominant frequencies during the rolling of the gearing.

8. The method according to claim 1,
wherein
machine corrections for the gear grinding machine are determined on the basis of the results of the computer-implemented rolling test of the gearing, by a multi-objective optimization.

9. The method according to claim 8,
wherein
the machine corrections have changes for process parameters of the gear grinding machine,
wherein the process parameters lie within an n-dimensional process window,
wherein the process window is limited by process restrictions, such as maximum permissible axis and/or drive speeds and/or accelerations, collision structures within a machine area, maximum permissible tool and/or workpiece temperatures, or grinding burn.

10. The method according to claim 9,
wherein
an extrapolatable model is provided for at least one process parameter, such as a linear regression model, or an AI model,
wherein the extrapolatable model maps a correlation between the process parameter and a process constraint, and
wherein the extrapolatable model enables compliance with a process constraint to be checked for a change in the process parameter specified by the machine correction.

11. The method according to claim 9,
wherein
the process parameters resulting from the machine corrections are checked with regard to a stability criterion, in the respect
that the machine parameters are robust against process fluctuations, and/or
that the machine corrections reflect a stationary state of the gear grinding machine.

12. The method according to claim 1, wherein
the machine data comprise axis movements and/or axis accelerations and/or vibration data of one machine axis or several controlled machine axes of the gear grinding machine,
wherein the results of the computer-implemented rolling tests include periodic deviations of the actual geometry of the gearing from a nominal geometry of the gearing, and
wherein the data model depicts correlations between the periodic deviations of the actual geometry of the gearing and the axis movements and/or axis accelerations and/or vibration data of the gear grinding machine.

13. A method including the steps of:
carrying out a method according to claim 1 for a plurality of components; and
carrying out a test bench-based rolling test for one or more of the components to validate and/or improve the data model.
